(19) United States
(12) Patent Application Publication
(10) Pub. No.: US 2010/0171782 A1
(43) Pub. Date: Jul. 8, 2010

(54) IMAGE RECORDING APPARATUS

(75) Inventors: Takashi Kado, Shizuoka-ken (JP); Masashi Hiroki, Kanagawa-ken (JP); Atsushi Kubota, Shizuoka-ken (JP); Satoshi Kaiho, Kanagawa-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/644,397

(22) Filed: Dec. 22, 2009

Related U.S. Application Data
(60) Provisional application No. 61/142,526, filed on Jan. 5, 2009.

(51) Int. Cl. B41J 29/38

(52) U.S. Cl. 347/16

(57) ABSTRACT

An image recording apparatus includes at least one ink jet head having a plurality of ejection ports arranged herein to eject droplets to a recording medium, a conveyance section including a conveyance surface for conveying the recording medium and to convey the recording medium in a direction different from an arrangement direction of the respective ejection ports, a suction force generation section to generate a suction force to adsorb the recording medium onto the conveyance surface, a thickness detection section to detect a thickness of the recording medium, and a control section to suppress cockling generated in the recording medium according to the thickness of the recording medium.

### CROSS-REFERENCE TO RELATED APPLICATIONS

This application is based upon and claims the benefit of priority from: U.S. Provisional Application No. 61/142,526 filed on Jan. 5, 2009, the entire contents of each of which are incorporated herein by reference.

### TECHNICAL FIELD

The present invention relates to an image recording apparatus to eject a droplet of ink or the like to a recording medium and to perform recording.

### BACKGROUND

As an image recording apparatus, there is an ink jet recording apparatus including an ink jet head. In the ink jet recording apparatus, while a recording medium such as a paper is conveyed by a conveyance section, a droplet of ink or the like is ejected from the ink jet head to perform recording on the recording medium. In the ink jet recording apparatus, there is a case where a so-called cockling phenomenon occurs in which the recording medium absorbs a large quantity of ink and swells to have a wavy shape. When the cockling phenomenon occurs, the distance between an ejection port of the ink jet head and the recording medium is not kept constant but varies.

In a portion of the recording medium where the cockling phenomenon occurs, as compared with a portion where the cockling phenomenon does not occur, the distance between the ejection port of the ink jet head and the recording medium becomes narrow. Thus, a variation in flying distance of the droplet of ink or the like ejected from the ink jet head occurs between the portion where the cockling phenomenon occurs and the portion where it does not occur. By this variation, there is a fear that uneven recording occurs on the recording medium, or the recording medium contacts with the ink jet head and is soiled.

In order to suppress the variation caused by the cockling phenomenon, the ink jet recording apparatus is provided with a suction apparatus which causes the recording medium to be forcibly adsorbed onto a conveyance surface of a conveyance section.

For example, JP-A-2003-118182 discloses to suppress a variation caused by the cockling phenomenon. In the publication, a conveyance section to convey a recording medium and a suction unit to cause a recording medium to be adsorbed and held on an adsorbing surface in a conveyance section are provided, and the suction force of the suction unit is changed according to the type of the recording medium through a user interface. In the publication, when recording is performed on the recording medium having a large cockling, the suction force by the suction unit is increased, the recording medium is strongly adsorbed to the conveyance surface of the conveyance section to suppress the cockling, and the variation in distance between the recording medium and the head is decreased.

However, in the publication, the user is requested to select the type of the recording medium each time the recording operation is performed, and the user's operation to perform high quality recording is troublesome.

### SUMMARY

An image recording apparatus according to a first aspect of the present invention comprises at least one ink jet head having a plurality of ejection ports arranged herein to eject droplets to a recording medium; a conveyance section including a conveyance surface for conveying the recording medium and to convey the recording medium in a direction different from an arrangement direction of the respective ejection ports; a suction force generation section to generate a suction force to adsorb the recording medium onto the conveyance surface; a thickness detection section to detect a thickness of the recording medium; and a control section to suppress cockling generated in the recording medium according to the thickness of the recording medium.

An image recording method according to a second aspect of the present invention comprises conveying a recording medium by a conveyance section, detecting a thickness of the recording medium if a droplet is ejected from an ink jet head to the conveyed recording medium, and suppressing cockling generated in the recording medium according to the thickness of the recording medium.

### DESCRIPTION OF THE DRAWING

FIG. 1 is a structural view showing an image recording apparatus of a first embodiment of the invention.

FIG. 2 is a structural view showing a record control section in the apparatus.

FIG. 3 is a cockling control flowchart in the apparatus.

FIG. 4 is a cockling control flowchart in an image recording apparatus of a second embodiment of the invention.

FIG. 5 is a structural view showing an image recording apparatus of a third embodiment of the invention.

FIG. 6 is a structural view showing an image recording apparatus of a fifth embodiment of the invention.

FIG. 7 is a structural view showing an image recording apparatus of a sixth embodiment of the invention.

FIG. 8 is a structural view showing an image recording apparatus of a seventh embodiment of the invention.

FIG. 9 is a structural view showing a record control section in the apparatus.

FIG. 10 is a cockling control flowchart in the apparatus.

FIG. 11 is a structural view showing an image recording apparatus of an eighth embodiment of the invention.

### DETAILED DESCRIPTION

Hereinafter, a first embodiment of the invention will be described with reference to the drawings.

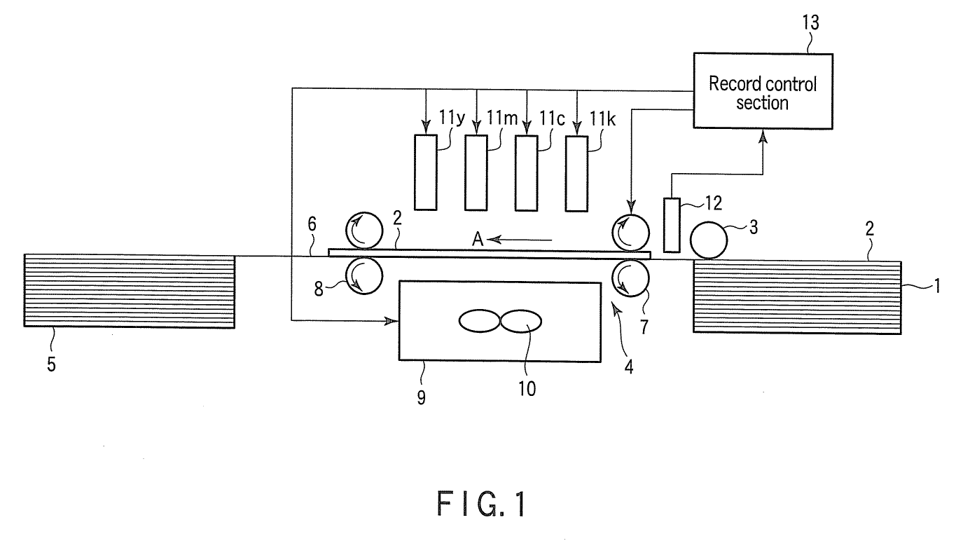

FIG. 1 is a structural view of an image recording apparatus. Plural recording media 2 are stacked and contained in a paper feed section 1. The recording media 2 include various types of papers such as a special paper for ink jet recording and standard paper. A pickup roller 3 is provided at the paper feed side of the paper feed section 1. The pickup roller 3 picks up a recording medium 2 at the uppermost position one by one among the plural recording media 2 contained in the paper feed section 1 and feeds it to a conveyance mechanism 4.

The conveyance mechanism 4 conveys the recording medium 2 fed from the paper feed section 1 to a paper discharge section 5. The conveyance mechanism 4 includes a conveyance surface (conveyance section) 6, and drive roller pairs 7 and 8 are respectively provided at a paper feed side and a paper discharge side of the conveyance surface 6. Each of the drive roller pairs 7 and 8 is rotated by a motor, and conveys the recording medium 2 on the conveyance surface 6 in an arrow A direction.

A suction section (suction force generation section) 9 is provided below the conveyance mechanism 4. The suction section 9 generates a suction force to adsorb the recording medium 2 onto the conveyance surface 6. The suction section 9 includes, for example, a fan 10. The fan 10 rotates to generate an air flow from the conveyance surface 6 side to the fan 10 side, and causes the recording medium 2 to be adsorbed onto the conveyance surface 6 by the pressure difference between the conveyance surface 6 side and the fan 10 side.

For example, four ink jet heads 11k, 11c, 11m and 11y are disposed above the conveyance mechanism 4. The respective ink jet heads 11k, 11c, 11m and 11y are disposed at specified intervals in the conveyance direction A of the conveyance mechanism 4. Plural ejection ports to eject ink of each color, for example, black (K), cyan (C), magenta (M) or yellow (Y) are arranged in a line in each of the ink jet heads 11k, 11c, 11m and 11y. Each of the ink jet heads 11k, 11c, 11m and 11y is provided so that the arrangement direction of the ejection ports is the vertical direction to the conveyance direction A. The ink jet head 11k ejects ink of, for example, color K from the respective ejection ports. The ink jet head 11c ejects ink of, for example, color C from the respective ejection ports. The ink jet head 11m ejects ink of, for example, color M from the respective ejection ports. The ink jet head 11y ejects ink of, for example, color Y from the respective ejection ports. The number of the ink jet heads 11k, 11c, 11m and 11y is not limited to four, and for example, only at least one ink jet head may be disposed. For example, when only the ink jet head 11k is disposed, a monochrome image is recorded on the recording medium 2.

A thickness sensor 12 is provided at the upstream side of the respective ink jet heads 11k, 11c, 11m and 11y in the conveyance direction A and, for example, between the paper feed section 1 and the conveyance mechanism 4. The thickness sensor 12 detects the thickness of the recording medium 2 fed to the conveyance mechanism 4 from the paper feed section 1, and outputs a thickness detection signal. The thickness sensor 12 is, for example, a laser displacement meter. The thickness sensor 12 irradiates laser light to the recording medium 2, receives the reflected laser light from the recording medium 2, and detects the thickness of the recording medium 2 based on a period of time from the irradiation time of the laser light to the reception time of the reflected laser light. That is, the height position of the conveyance surface 6 of the conveyance mechanism 4 is fixed in the apparatus. The thickness of the recording medium 2 varies according to the type. When the recording medium 2 is conveyed on the conveyance surface 6 of the conveyance mechanism 4, the height position of the upper surface of the recording medium 2 varies according to the type of the recording medium 2. By the difference of the height position of the upper surface of the recording medium 2, the period of time from the irradiation time of the laser light to the reception time of the reflected laser light varies according to the type of the recording medium 2. Accordingly, the thickness sensor 12 can detect the thickness of the recording medium 2 based on the period of time from the irradiation time of the laser light to the reception time of the reflected laser light.

The thickness sensor 12 may have a mechanical structure including a contact lever. One end of the contact lever is rotatably supported, and the other end is brought into contact with the surface of the recording medium 2. The contact lever is rotated by the thickness of the recording medium 2 each time the recording medium 2 is fed from the paper feed section 1 to the conveyance mechanism 4 one by one. Accordingly, the thickness of the recording medium 2 can be detected by detecting the rotation angle of the contact lever.

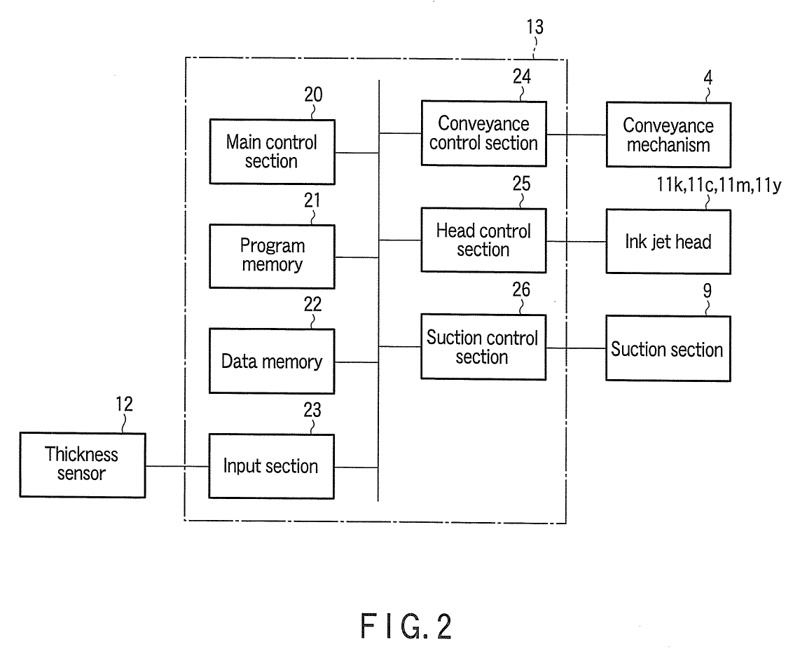

A record control section 13 controls a series of operations to record an image on the recording medium 2. FIG. 2 is a structural view of the record control section 13. The record control section 13 includes a main control section 20 including a CPU and the like. The record control section 13 includes a program memory 21, a data memory 22, an input section 23, a conveyance control section 24, a head control section 25 and a suction control section 26.

The program memory 21 stores a cockling control program. The cockling control program causes the conveyance mechanism 4 to convey the recording medium 2, and causes the main control section 20 to detect the thickness of the recording medium 2 and to suppress the cockling generated in the recording medium 2 according to the thickness of the recording medium 2 when the inks of the respective colors are ejected to the recording medium 2 from the respective ink jet heads 11k, 11c, 11m and 11y. The cockling control program causes the main control section 20 to vary the suction force to the recording medium 2 on the conveyance surface 6 of the conveyance mechanism 4 according to the thickness of the recording medium 2.

The thickness sensor 12 is connected to the input section 23. The input section 23 inputs the thickness detection signal outputted from the thickness sensor 12 to the record control section 13.

The conveyance control section 24 drives and controls the drive roller pairs 7 and 8 of the conveyance mechanism 4, and controls the conveyance operation of the recording medium 2 by the conveyance mechanism 4.

The head control section 25 controls the ejection of the inks of the respective colors of KCMY from the respective ink jet heads 11k, 11c, 11m and 11y.

The suction control section 26 controls the rotation number of the fan 10 of the suction section 9. When the rotation number of the fan 10 increases, the suction force to the recording medium 2 on the conveyance surface 6 increases. When the rotation number of the fan 10 decreases, the suction force to the recording medium 2 on the conveyance surface 6 decreases. In the suction control section 26, for example, a first rotation number in which the suction force increases and a second rotation number in which the suction force decreases are previously set. The suction control section 26 can set plural rotation numbers in addition to the first and the second rotation numbers.

The main control section 20 receives the thickness detection signal outputted from the thickness sensor 12, and suppresses the cockling generated in the recording medium 2 according to the thickness of the recording medium 2. Specifically, the main control section 20 varies the suction force according to the thickness of the recording medium 2. The main control section obtains the weight (basis weight) per certain area of the recording medium 2 based on the thickness of the recording medium 2, and varies the suction force generated by the suction section 9 according to the weight.

For example, the main control section 20 sends, to the suction control section 26, an instruction to decrease the suction force when the weight per certain area is a previously set value (hereinafter referred to as a set value), 80 g/m² or more, and an instruction to increase the suction force when the weight is the set value or less. The main control section 20 may obtain the weight per certain area based on the thickness of the recording medium 2 and the density of the recording medium 2.

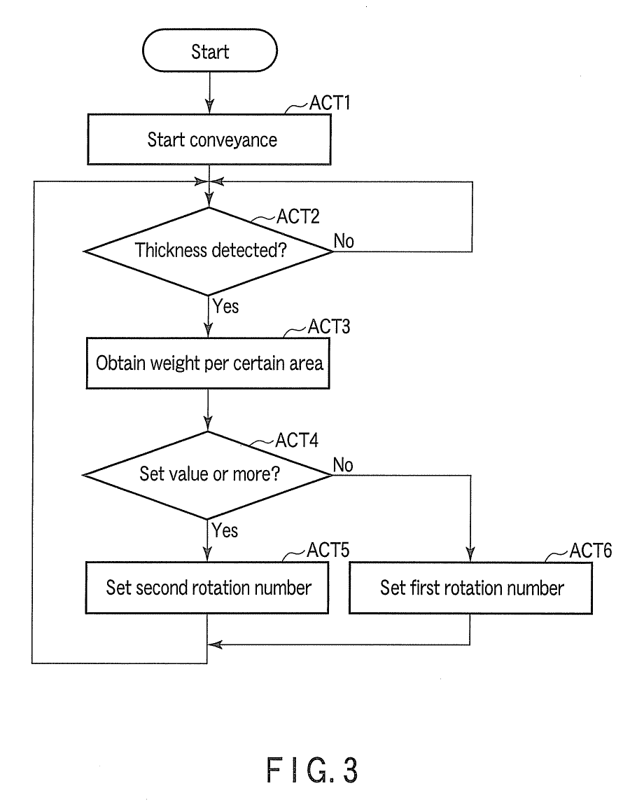

Next, the operation of the apparatus constructed as stated above will be described with reference to a cockling control flowchart shown in FIG. 3.

When the user inputs an instruction to start a record operation, the main control section 20 issues operation instructions to the paper feed section 1, the conveyance control section 24, the head control section 25 and the suction control section 26 (ACT 1). The pickup roller 3 picks up the recording medium 2 at the uppermost position one by one among the plural recording media 2 contained in the paper feed section 1, and feeds it to the conveyance mechanism 4.

The conveyance mechanism 4 drives the respective drive roller pairs 7 and 8 and is in a state where the recording medium 2 fed from the paper feed section 1 can be conveyed.

In this state, when the recording medium 2 is conveyed from the paper feed section 1 to the conveyance mechanism 4, the main control section 20 determines whether the detection signal of the thickness of the recording medium 2 from the thickness sensor 12 is detected (ACT 2). The thickness detection signal is inputted to the record control section 13 through the input section 23 and is sent to the main control section 20.

When the thickness detection signal is detected (YES at ACT 2), the main control section 20 receives the thickness detection signal outputted from the thickness sensor 12, and obtains the weight per certain area of the recording medium 2 based on the thickness of the recording medium 2 (ACT 3).

The main control section 20 determines whether the weight per certain area of the recording medium 2 is the previously set value, 80 g/m² or more (ACT 4).

As a result of this determination, when the weight per certain area of the recording medium 2 is the previously set value, 80 g/m² or more (YES at ACT 4), the main control section 20 sends, to the suction control section 26, an instruction to set the rotation number of the fan 10 at the previously set second rotation number (ACT 5).

On the other hand, when the weight per certain area is less than the set value, 80 g/m² (NO at ACT 4), the main control section 20 sends, to the suction control section 26, an instruction to set the rotation number of the fan 10 at the previously set first rotation number (ACT 6). The suction control section 26 controls the rotation number of the fan 10 to the first or the second rotation number in accordance with the instruction from the main control section 20. The first rotation number is larger than the second rotation number, that is, the suction force of the recording medium 2 at the first rotation number is larger.

As a result, the suction section 9 rotates the fan 10 at the first or the second rotation number, and generates the air flow from the conveyance surface 6 side to the fan 10 side. By this, the pressure difference occurs between the conveyance surface 6 side and the fan 10 side, and the recording medium 2 is adsorbed onto the conveyance surface 6. Accordingly, the conveyance mechanism 4 conveys the recording medium 2 in the state where the recording medium 2 is adsorbed onto the conveyance surface 6.

At the time of conveyance of the recording medium 2 by the conveyance mechanism 4, the ink jet head 11k ejects the ink of, for example, color K from the respective ejection ports. The ink jet head 11c ejects the ink of, for example, color C from the respective ejection ports. The ink jet head 11m ejects the ink of, for example, color M from the respective ejection ports. The ink jet head 11y ejects the ink of, for example, color Y from the respective ejection ports. The respective inks ejected from the respective ink jet heads 11k, 11c, 11m and 11y are impacted on the recording medium 2.

When the respective inks are impacted on the recording medium 2, the recording medium 2 absorbs a large quantity of ink and swells to have a wavy shape. In this case, when the weight per certain area of the recording medium 2 is the set value or more, the suction force caused by the fan 10 decreases. That is, when the weight per certain area of the recording medium 2 is the set value or more, the thickness of the recording medium 2 is thick. Even if the inks are impacted on the thick recording medium 2, the recording medium 2 hardly swells to have a wavy shape. Accordingly, the suction force generated by the fan 10 is set to be low.

On the other hand, when the weight per certain area of the recording medium 2 is the set value or less, the thickness of the recording medium 2 is thin. When the inks are impacted on the thin recording medium 2, the recording medium 2 often swells to have a wavy shape. Accordingly, the suction force generated by the fan 10 is set to be high. The recording medium 2 swelling to have the wavy shape is adsorbed onto the conveyance surface 6 of the conveyance mechanism 4, while the wavy shape is formed into a flat shape by the high suction force.

When the inks of the respective colors KCMY are impacted on the recording medium 2, a color image is recorded on the recording medium 2. The recording medium 2 on which the color image is recorded is sent to the paper discharge section 5.

As stated above, according to the first embodiment, the thickness sensor 12 detects the thickness of the recording medium 2. The main control section 20 obtains the weight per certain area of the recording medium 2 based on the thickness of the recording medium 2, and automatically varies the suction force generated by the suction section 9 according to the weight. For example, when the weight per certain area is the set value or more, the main control section 20 decreases the suction force, and when the weight is the set value or less, the main control section increases the suction force.

According to the type of the recording medium 2, for example, for the thick recording medium 2 which hardly swells to have a wavy shape even if ink is absorbed, the suction fore is automatically set to be low. For the thin recording medium 2 which swells to have a wavy shape when ink is absorbed, the suction force is automatically set to be high. Since the thin recording medium 2 is adsorbed onto the conveyance surface 6 of the conveyance mechanism 4 while the wavy shape is formed into the flat shape by the high suction force, the cockling is suppressed. The respective distances between the thin recording medium 2 and the respective ink jet heads 11k, 11c, 11m and 11y do not vary but are kept constant. As a result, even if the user does not perform a troublesome operation to select the type of the recording medium 2, a high quality image can be recorded on the recording medium 2.

When a color image is recorded on the recording medium 2, since the inks of KCMY overlap with each other and are impacted on the recording medium 2, the recording medium 2 is liable to swell to have a wavy shape. Also in this case, the main control section 20 can shape the wavy swell when the inks of KCMY overlap with each other on the recording medium 2. In the first embodiment of the invention, although the first rotation number is set when the weight is the set value or more, the control may be such that the first rotation number is made a default value, and when the weight does not exceed the set value, the rotation number is increased to the second rotation number. On the contrary, the control may be such that the second rotation number is made a default number, and when the weight is the set value or more, the rotation number is decreased to the first rotation number. Besides, the determination is set by “not more than” or “less than”.

Next, a second embodiment of the invention will be described with reference to the drawing. Since a structure of an image recording apparatus is the same as FIG. 1, the same figure is used and only a different point will be described.

A main control section 20 receives a thickness detection signal outputted from a thickness sensor 12, and varies the quantity of ink ejected from respective ejection ports of respective ink jet heads 11k, 11c, 11m and 11y according to the thickness of a recording medium 2. Specifically, the main control section 20 obtains the weight per certain area of the recording medium 2 based on the thickness of the recording medium 2, and varies the quantity of ink ejected from the respective ejection ports of the respective ink jet heads 11k, 11c, 11m and 11y according to the weight. For example, the main control section 20 sends, to a head control section 25, an instruction to increase the quantity of ink when the weight per certain area is a set value, 80 g/m² or more and an instruction to decrease the quantity of ink when the weight is the set value or less.

The head control section 25 controls the ejection quantities of inks of respective colors of KCMY from the respective ink jet heads 11k, 11c, 11m and 11y. The head control section 25 previously sets, for example, a first ink ejection quantity and a second ink ejection quantity. At this time, the first ink ejection quantity is larger than the second ink ejection quantity. The head control section 25 can set plural ink ejection quantities in addition to the first and the second ink ejection quantities.

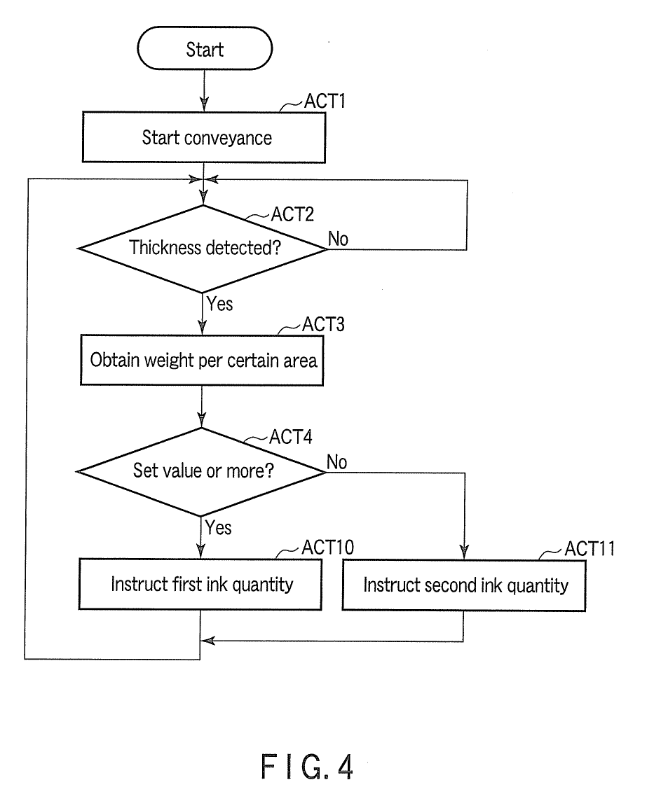

Next, the operation of the apparatus constructed as stated above will be described with reference to a cockling control flowchart shown in FIG. 4. The same portion as the first embodiment is denoted by the same sign and its description is omitted.

The main control section 20 determines whether the weight per certain area of the recording medium 2 is the previously set value, 80 g/m² or more (ACT 4).

As a result of the determination, when the weight per certain area is the set value, 80 g/m² or more (YES at ACT 4), the main control section 20 sends, to the head control section 25, an instruction to set the quantity of ink at the previously set first ink quantity (ACT 10). The head control section 25 increases the quantities of inks ejected from the respective ejection ports of the respective ink jet heads 11k, 11c, 11m and 11y in accordance with the instruction from the main control section 20.

On the other hand, when the weight per certain area is less than the set value, 80 g/m² (NO at ACT 4), the main control section 20 sends, to the head control section 25, an instruction to set the ink quantity at the previously set second ink quantity (ACT 11). The head control section 25 decreases the quantities of inks ejected from the respective ejection ports of the respective ink jet heads 11k, 11c, 11m and 11y in accordance with the instruction from the main control section 20. The first ink quantity is set to be larger than the second ink quantity.

As a result, when the weight per certain area of the recording medium 2 is the set value or more, the recording medium 2 is thick and can absorb a large quantity of ink. Even if a large quantity of ink is impacted, the thick recording medium 2 hardly swells to have a wavy shape.

On the other hand, when the weight per certain area of the recording medium 2 is less than the set value, the recording medium 2 is thin and there is a possibility that the recording medium swells to have a wavy shape by a small quantity of ink. Accordingly, the amount of impacted ink is decreased and it is possible to prevent the thin recording medium 2 from swelling to have a wavy shape.

A conveyance mechanism 4 drives respective drive roller pairs 7 and 8 and is in a state where the recording medium 2 fed from a paper feed section 1 can be conveyed. At the time of conveyance of the recording medium 2, a suction section 9 rotates a fan 10 at a previously set rotation number. By this, the conveyance mechanism 4 conveys the recording medium 2 in a state where the recording medium is adsorbed onto a conveyance surface 6 by a certain suction force.

As stated above, according to the second embodiment, the weight per certain area of the recording medium 2 is obtained based on the thickness of the recording medium 2, and the quantities of inks ejected from the respective ejection ports of the respective ink jet heads 11k, 11c, 11m and 11y are automatically varied according to the weight. For example, the weight per certain area is the set value or more, the main control section 20 automatically increases the quantity of ink, and when the weight is the set value or less, the control section automatically decreases the quantity of ink.

When the weight per certain area of the recording medium 2 is the set value or more and the recording medium 2 is thick, a larger quantity of ink can be absorbed, and even if a large quantity of ink is impacted, the recording medium hardly swells to have a wavy shape. When the weight per certain area of the recording medium 2 is the set value or less and the recording medium 2 is thin, there is a possibility that the recording medium swells to have a wavy shape by a small quantity of ink. Thus, the quantity of the impacted ink is decreased, and it is possible to prevent the recording medium from swelling to have a wavy shape.

Next, a third embodiment of the invention will be described with reference to the drawing. Incidentally, the same portion as FIG. 1 and FIG. 2 is denoted by the same sign, its detailed description is omitted, and only a different point will be described.

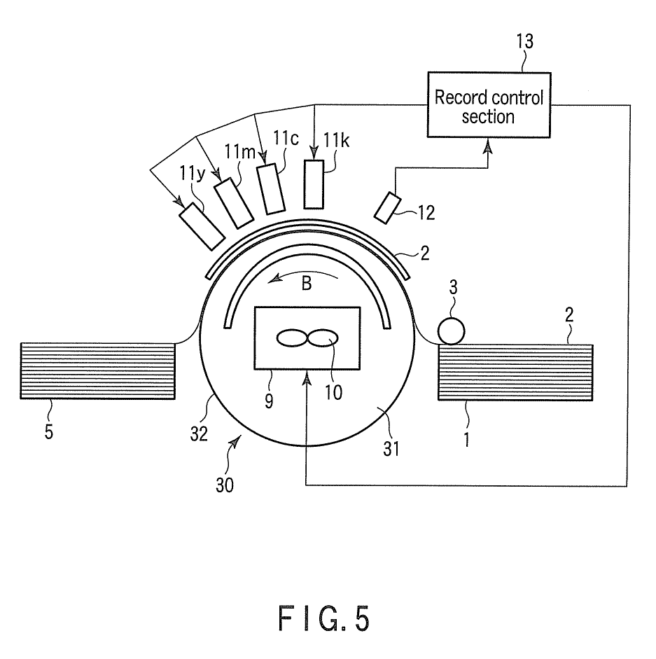

FIG. 5 is a structural view of an image recording apparatus. A conveyance mechanism 30 conveys a recording medium 2 fed from a paper feed section 1 to a paper discharge section 5. The conveyance mechanism 30 includes a conveyance main body 31 formed into, for example, a cylinder shape. The conveyance main body 31 is provided with a conveyance surface (conveyance section) 32 at an outer periphery. The conveyance main body 31 rotates at a certain rotation number in an arrow B direction by driving of a motor. A suction section 9 is provided in the conveyance main body 31. The suction section 9 generates a suction force to adsorb the recording medium 2 onto the conveyance surface 32. A fan 10 rotates to generate an air flow from the conveyance surface 32 side to the fan 10 side, and the recording medium 2 is adsorbed onto the conveyance surface 32 by a pressure difference between the conveyance surface 32 side and the fan 10 side.

The conveyance mechanism 30 rotates the conveyance main body 31 in a state where the recording medium 2 is adsorbed, and causes the recording medium 2 to pass through plural times under ink jet heads 11k, 11c, 11m and 11y.

The ink jet heads 11k, 11c, 11m and 11y are respectively disposed along a conveyance direction B. The ink jet heads 11k, 11c, 11m and 11y are respectively provided so that the respective distances to the conveyance surface of the conveyance main body 31 are equal to each other.

A thickness sensor 12 is provided above the conveyance surface 32 of the conveyance mechanism and faces the conveyance surface 32.

Since the operation of the apparatus constructed as stated above is the same as FIG. 3, its description is omitted. Incidentally, the third embodiment is different from the first embodiment in that the conveyance mechanism 30 rotates the conveyance main body 31 in the state where the recording medium 2 is adsorbed, and causes the recording medium 2 to pass through plural times under the ink jet heads 11k, 11c, 11m and 11y.

As a result, the suction section 9 rotates the fan 10 at a first or a second rotation number, and generates the air flow from the conveyance surface 32 side to the fan 10 side. By this, the pressure difference occurs between the conveyance surface 32 side and the fan 10 side, and the recording medium 2 is adsorbed onto the conveyance surface 32.

As stated above, according to the third embodiment, also when the conveyance mechanism 30 causes the recording medium 2 to pass through plural times under the ink jet heads 11k, 11c, 11m and 11y, the same effect as the first embodiment can be obtained.

Next, a fourth embodiment of the invention will be described. Since a structure of an image recording apparatus is the same as FIG. 5, the same figure is used and only a different point will be described.

A main control section 20 receives a thickness detection signal outputted from a thickness sensor 12, and varies the quantity of ink ejected from respective ejection ports of ink jet heads 11k, 11c, 11m and 11y according to the thickness of a recording medium 2. Specifically, the main control section 20 obtains the weight per certain area of the recording medium 2 based on the thickness of the recording medium 2, and varies the quantity of ink ejected from the respective ejection ports of the ink jet heads 11k, 11c, 11m and 11y according to the weight. For example, the main control section 20 sends, to a head control section 25, an instruction to increase the quantity of ink when the weight per certain area is a set value, 80 g/m² or more, and an instruction to decrease the quantity of ink when the weight is the set value or less.

Since the operation of the apparatus constructed as stated above is the same as FIG. 4, its description is omitted. Incidentally, the fourth embodiment is different from the first embodiment in that a conveyance mechanism 30 rotates a conveyance main body 31 in a state where the recording medium 2 is adsorbed, and causes the recording medium 2 to pass through plural times under the ink jet heads 11k, 11c, 11m and 11y.

Incidentally, at the time of conveyance of the recording medium 2, a suction section 9 rotates a fan 10 at a previously set constant rotation number. By this, the conveyance mechanism 30 conveys the recording medium 2 in the state where the recording medium is adsorbed onto a conveyance surface 32 by a certain suction force.

As stated above, according to the fourth embodiment, also when the conveyance mechanism 30 causes the recording medium 2 to pass through plural times under the ink jet heads 11k, 11c, 11m and 11y, the same effect as the second embodiment can be obtained.

Next, a fifth embodiment of the invention will be described with reference to the drawing. Incidentally, the same portion as FIG. 1 and FIG. 2 is denoted by the same sign, its detailed description is omitted, and only a different point will be described.

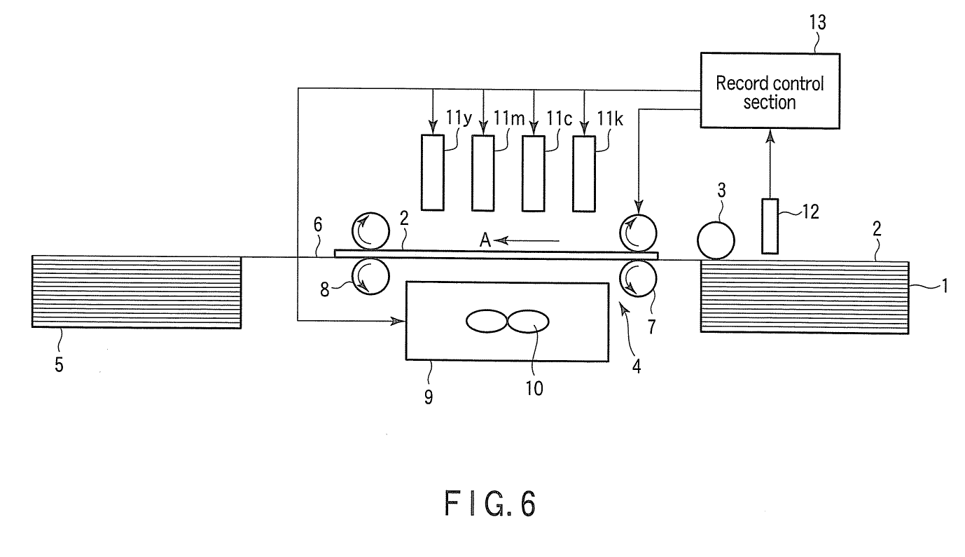

FIG. 6 is a structural view of an image recording apparatus. A thickness sensor 12 is provided above a paper feed section 1. Besides, the thickness sensor 12 is disposed upstream of a pickup roller 3 in a conveyance direction A. Respective recording media 2 contained in the paper feed section 1 are fed to a conveyance mechanism 4 one by one. In a period between a time when the conveyance medium 2 passes through just under the thickness sensor 12 to a time when the recording medium passes through the pickup roller 3, the height position of the uppermost position of the respective recording media 2 contained in the paper feed section 1 becomes low by the thickness of one recording medium 2. The thickness sensor 12 detects the thickness of one recording medium 2 from the difference between the height position of the recording media 2 before being fed and the height position of the stacked recording media 2 just after the recording medium passes through under the thickness sensor 12.

Next, the operation of the apparatus as constructed as stated above will be described. Since the operation is basically the same as FIG. 3, the illustration is omitted.

The pickup roller 3 picks up the recording medium 2 at the uppermost position one by one among the plural recording media 2 contained in the paper feed section 1 and feeds it to the conveyance mechanism 4.

The thickness sensor 12 detects the thickness of the recording medium 2. A thickness detection signal is sent to a main control section 20.

The main control section 20 receives the thickness detection signal outputted from the thickness sensor 12, and varies a suction force generated by a suction section 9 according to the thickness of the recording medium 2 similarly to the first embodiment. Incidentally, the main control section 20 receives the thickness detection signal outputted from the thickness sensor 12, obtains the weight per certain area of the recording medium 2 based on the thickness of the recording medium 2 similarly to the second embodiment, and may automatically vary the quantities of inks ejected from respective ejection ports of ink jet heads 11k, 11c, 11m and 11y according to the weight.

As stated above, according to the fifth embodiment, also when the thickness sensor 12 is provided above the paper feed section 1, the same effect as the first embodiment can be obtained.

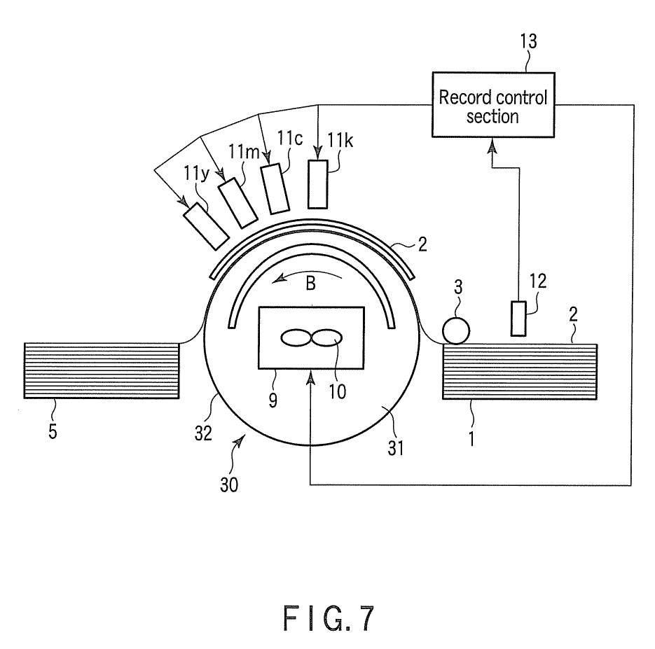

Next, a sixth embodiment of the invention will be described with reference to FIG. 7. The same portion as FIG. 5 is denoted by the same sign. A different point is an arrangement place of a thickness sensor 12. Since the arrangement place is similar to the fifth embodiment, the description including the operation is omitted.

As stated above, according to the sixth embodiment, also when the thickness sensor 12 is provided above a paper feed section 1, the same effect as the fourth embodiment can be obtained.

Next, a seventh embodiment of the invention will be described with reference to the drawing. Incidentally, the same portion as FIG. 1 is denoted by the same sign, its detailed description is omitted, and only a different point will be described.

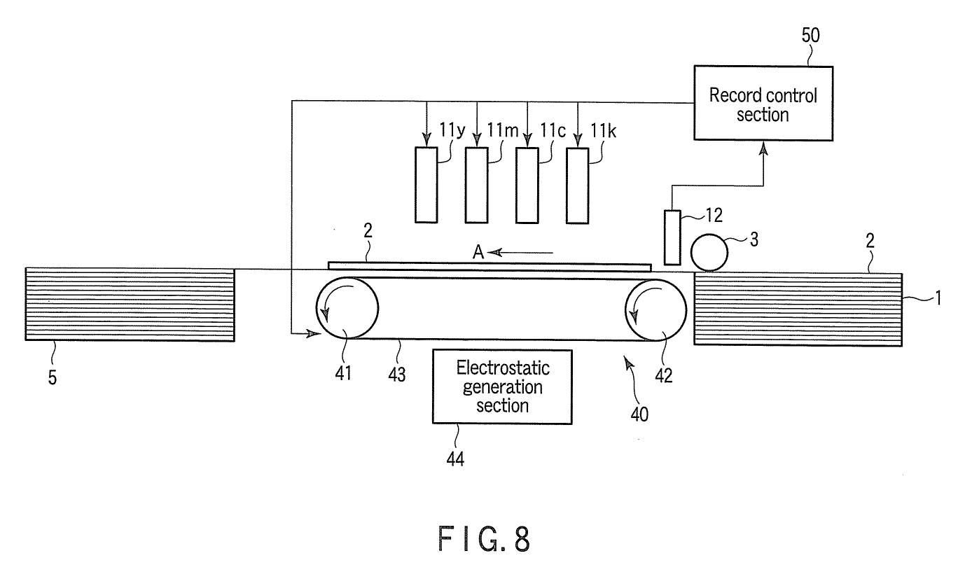

FIG. 8 is a structural view of an image recording apparatus. A conveyance mechanism 40 includes a drive roller 41, a driven roller 42 and an electrostatic adsorption belt 43. The electrostatic adsorption belt 43 is formed to have a band shape and to be endless. The electrostatic adsorption belt 43 is stretched over the drive roller 41 and the driven roller 42. The electrostatic adsorption belt 43 is charged with static electricity, and sucks the recording medium 2 by electrostatic force.

An electrostatic generation section (suction force generation section) 44 controls the amount of static electricity charged on the electrostatic adsorption belt 43, and varies the suction force to the recording medium 2 generated by the electrostatic adsorption belt 43.

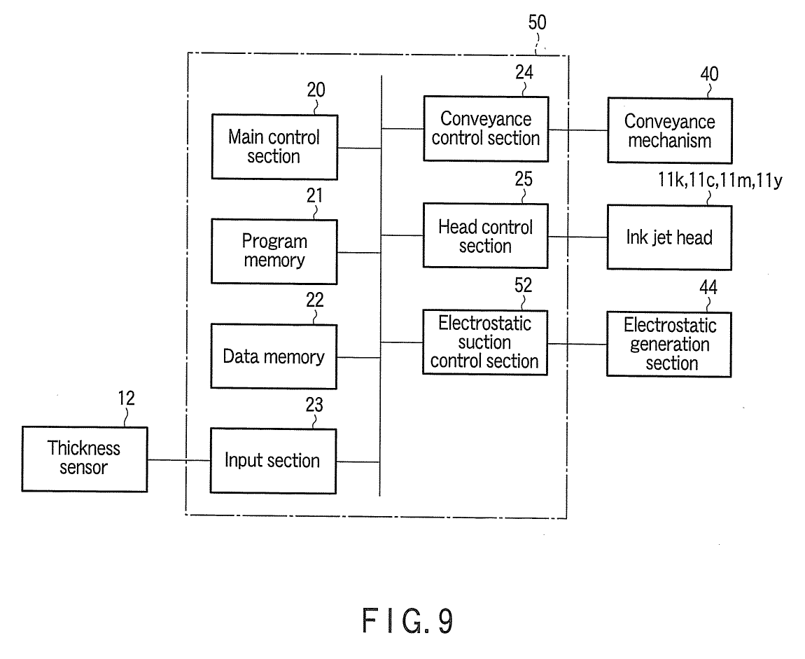

FIG. 9 is a structural view of a record control section 50. The record control section 50 includes an electrostatic suction control section 52.

The main control section 20 varies the suction force to the recording medium 2 generated by the electrostatic force of the electrostatic adsorption belt 43 according to the thickness of the recording medium 2. The main control section obtains the weight per certain area of the recording medium 2 based on the thickness of the recording medium 2, and varies the amount of static electricity generated by the electrostatic generation section 44 according to the weight.

For example, the main control section 20 sends, to the electrostatic suction control section 52, an instruction to set a first electrostatic force to decrease the suction force to the recording medium 2 generated by the electrostatic force when the weight per certain area is the previously established set value, 80 g/m² or more. The main control section 20 sends, to the electrostatic suction control section 52, an instruction to set a second electrostatic force to increase the suction force to the recording medium 2 generated by the electrostatic force when the weight per certain area is less than the previously established set value, 80 g/m².

The main control section 20 can set plural electrostatic forces in addition to the first and the second electrostatic forces.

The electrostatic suction control section 52 receives the instruction of the first or the second electrostatic force from the main control section 20, and controls the amount of static electricity charged on the electrostatic adsorption belt 43 by the electrostatic generation section 44.

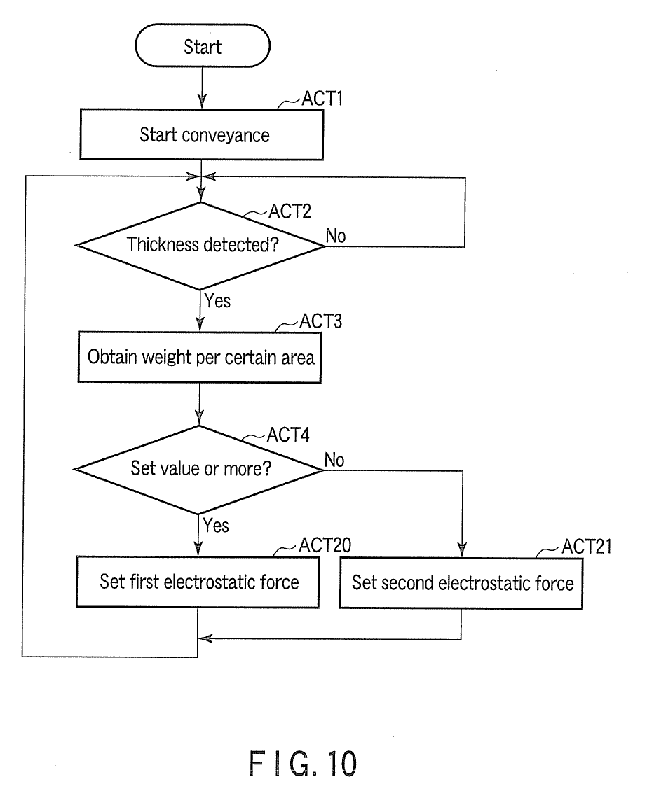

Next, the operation of the apparatus constructed as described above will be described with reference to a cockling control flowchart shown in FIG. 10. The same portion as FIG. 3 is denoted by the same sign and its description is omitted.

When the weight per certain area of the recording medium 2 is the set value, 80 g/m² or more (YES at ACT 4), the main control section 20 sends, to the electrostatic suction control section 52, an instruction to set the amount of static electricity charged on the electrostatic adsorption belt 43 to generate the first electrostatic force which causes the suction force of the electrostatic adsorption belt 43 (ACT 20).

On the other hand, when the weight per certain area of the recording medium 2 is less than the set value, 80 g/m² (NO at ACT 4), the main control section 20 sends, to the electrostatic suction control section 52, an instruction to set the amount of static electricity charged on the electrostatic adsorption belt 43 to generate the second electrostatic force which causes the suction force (ACT 21). The second electrostatic force is set to be larger than the first electrostatic force.

The electrostatic suction control section 52 receives the instruction of the first or the second electrostatic force from the main control section 20, and controls the amount of static electricity charged on the electrostatic adsorption belt 43 by the electrostatic generation section 44. As a result, the electrostatic generation section 44 charges the electrostatic adsorption belt 43 with static electricity the amount of which corresponds to the first or the second electrostatic force. By this, the suction force to the recording medium 2 generated by the electrostatic adsorption belt 43 is varied.

Accordingly, the conveyance mechanism 40 conveys the recording medium 2 in the state where the recording medium is adsorbed onto the electrostatic adsorption belt 43 by the first or the second electrostatic force.

In this case, when the weight per certain area of the recording medium 2 is the set value or more, the suction force by the electrostatic adsorption belt 43 decreases. That is, when the thick recording medium 2 is used, even if ink is impacted, the recording medium 2 hardly swells to have a wavy shape. Accordingly, the suction force by the electrostatic adsorption belt 43 is set to be low.

On the other hand, when the recording medium 2 is thin, the suction force by the electrostatic adsorption belt 43 is set to be high. The thin recording medium 2 is adsorbed onto the electrostatic adsorption belt 43 of the conveyance mechanism 40, while the wavy shape is formed into a flat shape by the high suction force.

As stated above, according to the seventh embodiment, the suction force to the recording medium 2 generated by the electrostatic force of the electrostatic adsorption belt 43 is varied according to the thickness of the recording medium 2. For example, when the weight per certain area is the previously established set value, 80 g/m² or more, the main control section 20 sets the first electrostatic force to decrease the suction force to the recording medium 2 generated by the electrostatic force. When the weight per certain area is less than the previously established set value, 80 g/m², the main control section 20 sets the second electrostatic force to increase the suction force to the recording medium 2 generated by the electrostatic force. According to the seventh embodiment, the same effect as the first embodiment can be obtained.

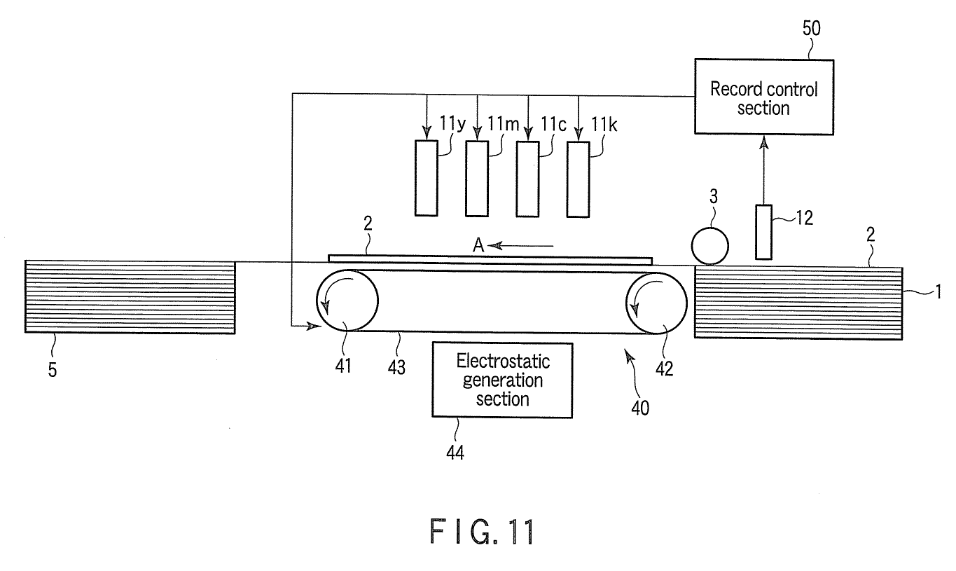

Next, an eighth embodiment of the invention will be described with reference to FIG. 11. The same portion as FIG. 8 is denoted by the same sign. A different point is an arrangement place of a sensor 12. Since the arrangement place is the same as the sixth embodiment, the description including the operation is omitted.

According to the eighth embodiment, also when the thickness sensor 12 is provided above a paper feed section 1, the same effect as the seventh embodiment can be obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image recording apparatus comprising:
at least one ink jet head having a plurality of ejection ports arranged herein to eject droplets to a recording medium;
a conveyance section including a conveyance surface for conveying the recording medium and to convey the recording medium in a direction different from an arrangement direction of the respective ejection ports;
a suction force generation section to generate a suction force to adsorb the recording medium onto the conveyance surface;
a thickness detection section to detect a thickness of the recording medium; and
a control section to suppress cockling generated in the recording medium according to the thickness of the recording medium.

2. The apparatus according to claim 1,
wherein the control section causes the suction force generation section to vary the suction force according to the thickness of the recording medium.

3. The apparatus according to claim 2,
wherein the suction force generation section generates a pressure difference to generate the suction force.

4. The apparatus according to claim 2,
wherein the suction force generation section generates an electrostatic force to generate the suction force.

5. The apparatus according to claim 2,
wherein the conveyance section conveys the same recording medium at lease once under the ink jet head.

6. The apparatus according to claim 2,
wherein the control section obtains a weight per certain area of the recording medium based on the thickness of the recording medium, and causes the suction force to vary according to the weight.

7. The apparatus according to claim 6;
wherein if the weight is more than a previously set value, the control section decreases the suction force, and if the weight is the set value less than the previously set value, the control section increases the suction force.

8. The apparatus according to claim 2,
wherein the control section causes a quantity of the droplets ejected from the respective ejection ports according to the thickness of the recording medium.

9. The apparatus according to claim 8,
wherein the control section obtains a weight per certain area of the recording medium based on the thickness of the recording medium, and causes the quantity of the droplets to vary according to the weight.

10. The apparatus according to claim 9,
wherein if the weight is a previously set value or more, the control section increases the quantity of the droplets, and if the weight is the value or less, the control section decreases the quantity of the droplets.

11. The apparatus according to claim 1,
wherein the thickness detection section includes a laser displacement meter.

12. The apparatus according to claim 1,
wherein the thickness detection section is provided upstream of the ink jet head in a conveyance direction of the conveyance section.

13. The apparatus according to claim 1, further comprising:
a paper feed section to feed the recording medium to the conveyance section,
wherein the thickness detection section is provided between the paper feed section and the conveyance section.

14. The apparatus according to claim 1, further comprising:
a paper feed section to feed the recording medium to the conveyance section,
wherein the thickness detection section is provided above the paper feed section.

15. The apparatus according to claim 1,
wherein a plurality of the ink jet heads are provided and are arranged in a conveyance direction of the recording medium.

16. An image recording apparatus comprising:
a recording means that includes a plurality of ejection ports arranged herein to eject droplets to a recording medium;
a conveyance means that includes a conveyance surface for conveying the recording medium and conveys the recording medium in a direction different from an arrangement direction of the respective ejection ports;
a suction force generation means for generating a suction force to adsorb the recording medium onto the conveyance surface;
a thickness detection means for detecting a thickness of the recording medium; and
a control means for suppressing cockling generated in the recording medium according to the thickness of the recording medium.

17. The apparatus according to claim 16,
wherein the control means causes the suction force generation means to vary the suction force according to the thickness of the recording medium.

18. An image recording method comprising:
conveying a recording medium by a conveyance section;
detecting a thickness of the recording medium if a droplet is ejected from an ink jet head to the conveyed recording medium; and
suppressing cockling generated in the recording medium according to the thickness of the recording medium.

19. The method according to claim 18,
wherein a suction force to the recording medium on a conveyance surface of the conveyance section is varied according to the thickness of the recording medium.

20. The method according to claim 18,
wherein a quantity of the droplet ejected from the ink jet head is varied according to the thickness of the recording medium.
